(19) United States
(12) Patent Application Publication
(10) Pub. No.: US 2013/0026033 A1
(43) Pub. Date: Jan. 31, 2013

(54) SEALING-TYPE WATER PURIFIER AND WATER-PURIFYING METHOD FOR PRODUCING ELECTROLYZED HYDROGEN-CONTAINING PURE COLD AND HOT WATER AND PREVENTING CONTAMINATION CAUSED BY MICROORGANISMS AND FOREIGN CONTAMINANTS

(71) Applicant: Un Sang Ji, Gyeonggi-do (KR)

(72) Inventor: Un Sang Ji, Gyeonggi-do (KR)

(21) Appl. No.: 13/386,628

(22) PCT Filed: Jul. 26, 2010
(86) PCT No.: PCT/KR2010/004871

§ 371 Date: Feb. 24, 2012

(30) Foreign Application Priority Data
Jul. 24, 2009 (KR) 10-2009-0068075

(51) Int. Cl. C02F 1/461

(52) U.S. Cl. 204/276

(57) ABSTRACT

The present invention relates to an electrolyzed hydrogen-containing hot and cold water purifier for producing hydrogen water by dissolving hydrogen gas generated by electrolysis in raw water, and more particularly, to a sealing-type electrolyzed hydrogen-containing hot and cold water purifier and a water-purifying method for preventing microorganisms and foreign contaminants from being incorporated.

### TECHNICAL FIELD

The present invention relates to an electrolyzed hydrogen-containing hot and cold water purifier for producing hydrogen water by dissolving hydrogen gas generated by electrolysis in raw water, and more particularly, to a sealing-type electrolyzed hydrogen-containing hot and cold water purifier and a water-purifying method for preventing microorganisms and foreign contaminants from being incorporated.

### BACKGROUND ART

A great quantity of chemical substances, organic chlorine solvents, and carcinogenic compounds are incorporated in tap water due to contamination of a river and a water supply source caused by industrial development and population growth and chlorine treatment in a purification plant and furthermore, people cannot trust and drink the tap water as even a problem regarding a superannuated water pipe is raised.

At present, in Korea, hundreds of water purifiers have already propagated and the propagation of the water purifier has steadily increased in the present situation in which even the tap water as well as groundwater threatens safety and health due to various water pollutions (factory wastes, domestic sewage, leachate and the like) resulting from advanced industrial development.

As a result, our human bodies are threatened from the drinking water due to secondary contaminations such as foreign contaminations and various bacteria due to sales gimmicks and indiscrete overrun of the purifiers and in recent years, seriousness of the problem is reported to the press.

However, the existing purifier just removes harmful substances or provides water only having short mineral. There is almost no functional water purifier assisting health domestically and abroad and a similar functional water purifier among imported goods is very expensive.

Meanwhile, oxygen as one of the most common elements in Earth's atmosphere makes up 21% of the atmosphere and human breathes the oxygen to acquire energy for surviving

Although oxygen is absolutely required for sustaining life, ground state triplet oxygen which is in a stable molecular state is converted into active oxygen having very high reactivity due to physical, chemical, and environmental factors such as an in-body enzyme system, reduced metabolism, pollution substances, photochemical reaction, and the like to cause harmful oxide toxicity to a human body.

It has been reported that they exert a non-selective and irreversible destruction action on lipid, protein, sugar, DNA, and the like as cell constituting components to cause various diseases including cancer as well as the aging process (Free Radical Theory, Professor Denhum Harman at the University of Nebraska Medical Center College in 1954).

In recent years, a water purifier has been introduced that provides drinkable electrolyzed water which is weak alkali water of pH 7.4 to 8.5 and a general structure of the water purifier is constituted by a water purifying unit and an electrolyzing unit.

The water purifying unit adopts a method that allows raw water to flow to nonwoven fabric, sand, anthracite, and activated carbon from the top to the bottom or from the bottom to the top and then a pressurization pump is used or omitted when a reverse osmosis membrane separating module is used, and another method in which the raw water passes through an ultrafiltration membrane module and then passes through the activated carbon or a ceramic filter in sequence as a post-treatment and is sent to an electrolysis tank.

In this case, when the electrolysis tank as an open type covering an upper cover is cooled by a small-sized cooler by stacking cooling coils in multilayers outside the electrolysis tank for cooling, purified cold water is provided to an outlet of an internal bottom surface of the electrolysis tank and can be provided to even a hot-water tank installed below the electrolysis tank through another outlet at a lower center position of the electrolysis tank.

In the electrolyzing unit where the electrolysis occurs, one positive electrode plate and two negative electrode plates are installed between two partition membranes configured so as to enable only movement of ions included in water, and as a result, three electrode chambers are provided to generate strong alkali water (pH 9 to 10) and weak alkali water (pH 7.4 to 8.5) from two negative electrode chambers and electrolyzed ion water of acid water (pH 5 to 6) from a positive electrode chamber, such that the drinkable alkali water among them is used as drinking water.

In an alkali ion purifier, since opened tanks are used, microorganisms and foreign contaminants are incorporated to be harmful in the electrolysis tank to the human body and there is additionally recommended a reference item that generation of trihalomethane should not be increased as compared with the raw water by chlorine ions included in water.

### DISCLOSURE

### Technical Problem

The present invention is contrived to solve the problems and there is an object of the present invention to provide a sealing-type electrolyzed hydrogen-containing hot and cold water purifier and a water-purifying method for preventing microorganisms and various foreign contaminants from being incorporated, which can completely prevent incorporation of the foreign contaminants and contamination of the microorganisms caused during purification, and generating, storing and supplying electrolyzed hydrogen assisting health to clearly purified water.

### Technical Solution

In order to achieve the above object, in a sealing-type electrolyzed hydrogen-containing hot and cold water purifier for preventing microorganisms and foreign contaminants from being incorporated according to the present invention, which is constituted by a water purifying unit sending purified water filtered from raw water to an electrolysis tank and an electrolyzing unit generating and storing electrolyzed hydrogen water by dissolving the hydrogen gas, generated by electrolyzing the purified water from the electrolysis tank, to raw water, and the electrolysis tank is formed in a sealing type and an air vent filter and a check valve are mounted on the top of the water purifying tank.

Further, the air vent filter may be configured by a pore having a size in the range of 0.01 to 0.2 μm.

In addition, as pipes associated with the hydrogen water, all pipes leading to water taking points may be made of titanium.

A sealing-type electrolyzed hydrogen-containing hot and cold water purifying method for preventing microorganisms and foreign contaminants from being incorporated according to the present invention comprises: a water purifying process in which raw water is supplied from the outside to remove taste, odor, color, particulates, high salt (mineral), disinfection by-products and pesticide residues; an electrolyzed hydrogen generating and storing process in which purified water is electrolyzed to generate hydrogen and the generated electrolyzed hydrogen is stored in a compressed activated carbon block provided on the top of an electrolysis tank; and an electrolyzed hydrogen water supplying process in which a solenoid valve connected to an air vent filter is actuated to exhaust air to the outside, thereby facilitating the flow of water in a pipe to supply the electrolyzed hydrogen water. Further, the method may further comprise a washing process as a process of removing scales in the electrolysis tank and on electrode bars and slime in the pipe.

### Advantageous Effects

According to a sealing-type electrolyzed hydrogen-containing hot and cold water purifier and a water-purifying method for preventing microorganisms and various foreign contaminants from being incorporated of the present invention, a cooling tank, a hot-water tank, and an electrolysis tank are sealed in order to interrupt air contact with the outside, thereby fundamentally solving proliferation of various bacteria which are proliferated and propagated after the electrolysis tank.

### DESCRIPTION OF DRAWINGS

FIG. 1 is a block diagram for describing a water purifying process of a sealing-type electrolyzed hydrogen-containing hot and cold water purifier for preventing microorganisms and foreign contaminants from being incorporated according to an embodiment of the present invention.

FIG. 2 is a schematic diagram for describing a lower structure of an electrolysis tank according to an embodiment of the present invention.

FIG. 3 is a front view showing a structure of an electrolysis tank of a sealing-type electrolyzed hydrogen-containing hot and cold water purifier for preventing microorganisms and foreign contaminants from being incorporated according to an embodiment of the present invention.

### REFERENCE NUMBER

100: Water purifying unit
200: Electrolyzing unit
110: First filter
120: Second filter
130: Third filter
140: Membrane contactor
210: Electrolysis tank
220: Hydrogen storing filter
230: Air vent filter
240: Automatic solenoid valve
250: Check valve
211: Purified water inlet
212: Positive electrode bar
213: Negative electrode bar
214: Vibrator
215: Float switch
216: Lower center outlet
217: Monitoring window
218: Light emitting lamp
221: Activated carbon filter
222: Ceramic filter
300: Ice maker
400: Cooling tank
500: Hot water tank
600: Multi-Purpose Hydrogen water tank

### BEST MODE

Hereinafter, a configuration and an operation of embodiments of the present invention will be described in detail with reference to the accompanying drawings so that they can be easily carried out by those skilled in the art.

The configuration and operation of the present invention illustrated in the drawings and described with reference to the drawings are described as at least one embodiment and the core configuration and operation of the present invention are not limited thereto.

Accordingly, since various modifications can be made and various embodiments can be achieved in the present invention, it should be understood that all modifications, equivalents, or substitutions are included in the scope of the present invention.

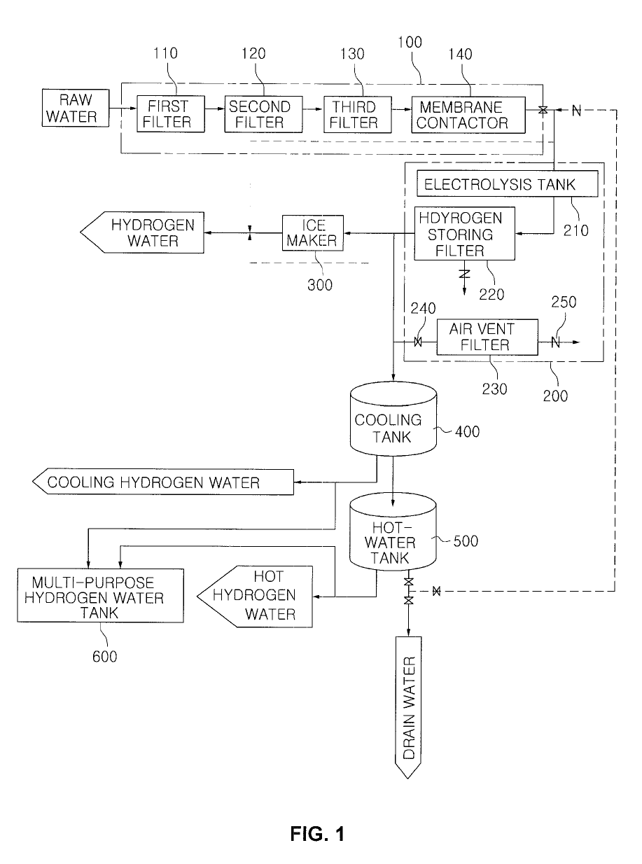

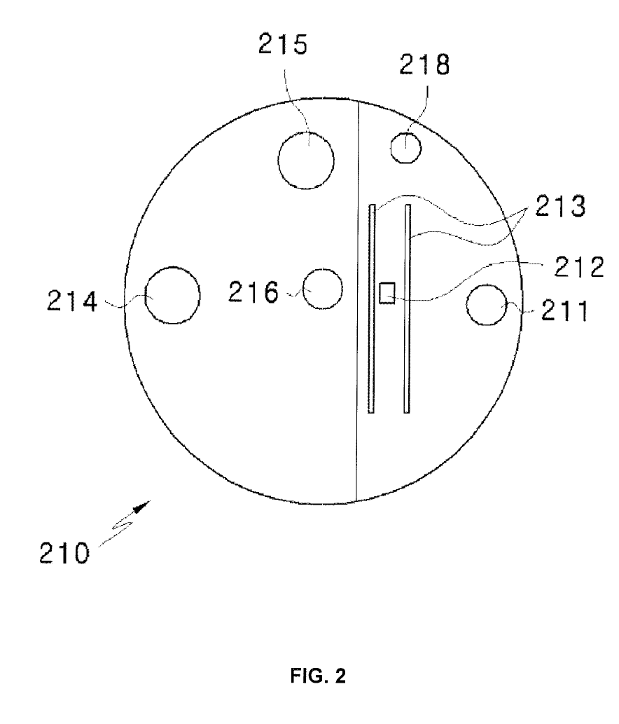

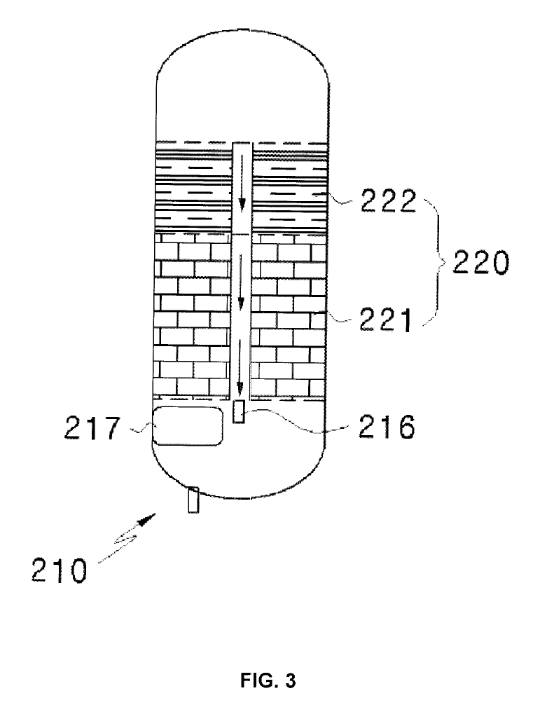

FIG. 1 is a block diagram for describing a water purifying process of a sealing-type electrolyzed hydrogen-containing hot and cold water purifier for preventing microorganisms and foreign contaminants from being incorporated according to an embodiment of the present invention. FIG. 2 is a schematic diagram for describing a lower structure of an electrolysis tank according to an embodiment of the present invention. FIG. 3 is a front view showing a structure of an electrolysis tank of a sealing-type electrolyzed hydrogen-containing hot and cold water purifier for preventing microorganisms and foreign contaminants from being incorporated according to an embodiment of the present invention.

As shown in FIG. 1, the sealing-type electrolyzed hydrogen-containing hot and cold water purifier for preventing microorganisms and foreign contaminants from being incorporated includes a water purifying unit 100 and an electrolyzing unit 200.

The water purifying unit 100 is configured to send purified water filtered from raw water to an electrolysis tank 210.

The electrolyzing unit 200 is configured to generate and store electrolyzed hydrogen water by electrolyzing the water purified by the electrolysis tank 210 and is acquired by manufacturing the electrolysis tank 210 in a sealing type and mounting an automatic solenoid valve 240, an air vent filter 230, and a check valve 250 on the top of the electrolysis tank 210.

In this case, the air vent filter 230 is preferably configured by a pore having a size in the range of 0.2 to 0.01 μm and the electrolysis tank 210 is made of a material such as transparent polysulfone and all pipes from a hydrogen storing filter 220 to each water taking point are preferably made of a titanium material.

Therefore, in the present invention, the purified water can be prevented incrustation, slime, a dead substance of vermin and various microorganisms (general bacteria, water-borne contagion bacteria, Escherichia coli, and fungus, and the like) which are problems in an open-type tank from being introduced from the outside and proliferated.

Further, as various researches show that the purified water is beneficial to a human body by suppressing atopic dermatitis, various cancers, aging, and the like, the electrolyzed hydrogen water having sufficient electrolyzed hydrogen (alternatively, activated hydrogen) contained in the purified water is technologically stored and provided.

As shown in FIG. 1, the raw water as ground water, tap water, or water having total dissolved solids (TDS) of 50 to 5,000 mg/liter passes through a first filter 110, a second filter 120, and a third filter 130 in sequence via a manual or automatic valve at water pressure in the range of 1 to 3 kg·force/cm².

The first filter 110, which is acquired by cylindrically coated powders and fibrous or particulate activated carbon with nonwoven fabric, serves to primarily remove taste, odor, color, particulates, disinfection by-products and pesticide residues as the raw water passes from the top to the bottom.

The second filter 120 purifies the raw water by a reverse osmosis method when the raw water having total dissolved solids (alternatively, salt) concentration of 200 mg/liter or more is processed and in this case, the raw water is processed by using a pressurization pump (booster) not shown in figures when the pressure of the raw water is low or the salt concentration is high.

Further, when the raw water having the salt concentration of 200 mg/liter or less is processed, a microfiltration method using a film-formed filter that is a hollow fiber type, tubular type, spiral wound type, or plate and frame type polymer synthetic material or an inorganic material such as ceramic and etc. may be used and an ultrafiltration method may also be used.

The third filter 130 that is a cylindrical filter filled with a cationic exchange resin or a chelated resin in the nonwoven fabric serves to remove soluble lead (Pb) that exists in the raw water and a cast iron pipe. In this case, as necessary, when the reverse osmosis method is used in the second filter 120, the third filter process may be omitted.

The water passing through the first filter 110, the second filter 120, and the third filter 130 enters the electrolysis tank via a membrane contactor 140.

The membrane contactor 140 which is used to remove gases dissolved in the purified water can remove the dissolved gases in the purified water more effectively when vacuum is applied at a degassing outlet.

Thereafter, when the degassed purified water is introduced into the cylindrical or quadrangular electrolysis tank 210, current flows on positive and negative electrode bars acquired by platinum-coating titanium or stainless steel to generate electrolyzed hydrogen.

That is, as shown in FIG. 2, the purified water is supplied at a purified water inlet 211 provided in an lower inner part of the electrolysis tank 210 and direct current flows while the electrode bar (alternatively, electrode plate) is arranged thereon with a positive (+) pole and a negative (−) pole facing each other.

In this case, in the positive electrode bar 212, a reaction of H₂O→½O₂+2H⁺+2e⁻ occurs, while in the negative electrode bar 213, a reaction of 2H₂O+2e⁻→H₂+2OH⁻ occurs.

Therefore, while oxygen is generated from a positive electrode and hydrogen is generated from a negative electrode, hydrogen ions (H⁺) are generated from the positive electrode and hydroxyl ions (OH⁻) are generated from the negative electrode. The hydrogen ions (H⁺) change water into acidity and the hydroxyl ions (OH⁻) change water into alkalinity, but since they exist in the same quantity, a hydrogen ion concentration (pH) is not changed in overall.

Meanwhile, a vibrator 214 or a rotary motor vane is installed on the bottom of the electrolysis tank 210 in order to promote electrolysis at another position and subsequently, a float switch 215 is attached.

Therefore, as shown in FIGS. 2 and 3, when hydrogen is saturated in a hydrogen storing filter 220 installed at the center of the electrolysis tank 210, the float switch not shown in the figures moves up from the bottom to the top to interrupt electrolysis power. In this case, a transparent monitoring window 21′7 so as to view an electrolysis state even in the outside and a small-sized light emitting lamp (LED) 218 is provided in the lower part of the electrolysis tank 210 to be on/off in association with an electrolysis reaction.

The electrolyzed hydrogen generated by the electrolysis is stored in the cylindrical or quadrangular hydrogen storing filter 220 installed at a protruding portion at the lower center of the electrolysis tank 210. The hydrogen storing filter serves to store the electrolyzed hydrogen in a micro hole coupled with internal compressed activated carbon or a ceramic filter through the surface packaged with the nonwoven fabric.

Thereafter, when the electrolyzed hydrogen is saturated in the hydrogen storing filter 220, the stored electrolyzed hydrogen is discharged together with water through a lower center outlet 216 of the electrolysis tank by water taking and when the water taking is completed, the water in the hydrogen storing filter 220 is automatically drained to the lower part to which the check valve is attached to increase an electrolyzed hydrogen storing area.

Herein, the hydrogen storing filter 220 comprises an activated carbon filter 221 consolidation-blocking particulate, fibrous, or powdered activated carbon with ultrafine holes or consolidation-blocking with activated carbon, and a ceramic filter 222 made of ceramics and configured by a pore having a size in the range of 0.1 to 0.01 μm on the activated carbon filter as shown in FIG. 3 in order to store more electrolyzed hydrogen.

The purified water containing the stored electrolyzed hydrogen as shown in FIG. 1 may be used as ice or particulate ice-making water through an ice maker 300 or may be configured to make it possible to drink the electrolyzed hydrogen water directly. Further, cold hydrogen water may be drunk via a cooling tank 400 cooling water indirectly by winding an outer surface thereof with a cooling coil or hot hydrogen water may be drunk via a hot-water tank 500 heating water in an indirect heating method.

The cold and hot hydrogen water may be taken by using a push or touch button in an electronic or electric scheme such as a photo sensor at the time of drinking.

In this case, since a solenoid valve connected to the air vent filter 230 with the a pore having the size in the range of 0.2 to 0.01 μm is automatically opened and closed, a difficulty in drinking due to bubbles or dissolved gas is prevented and a check valve 250 dually interrupts introduction of air from the outside.

A sealing-type electrolysis tank is able to interrupt air contact from the outside by the automatic solenoid valve 240, the air vent filter 230, and the check valve 250 being provided so that the problem of proliferation of various bacteria in the electrolysis tank can be solved fundamentally.

Further, based on the reports that the hydrogen water is effective even to remove atopic dermatitis, chloasma, freckles, and the like, and help whitening, water is supplied with a multi-purpose hydrogen water tank 600 which can be carried to a desired distance and a desired place by finishing T-shaped piping parts and connection pipe materials with heat insulation materials in each internal water inlet of the hot and cold hydrogen water purifier to achieve an effect of two or more purifiers with one hot and cold hydrogen water purifier.

A sealing-type electrolyzed hydrogen-containing hot and cold water purifying method for preventing microorganisms and foreign contaminants from being incorporated according to an embodiment of the present invention comprises a water purifying process, an electrolyzed hydrogen generating and storing process, and an electrolyzed hydrogen water supplying process.

In the water purifying process of the sealing-type electrolyzed hydrogen-containing hot and cold water purifying method for preventing microorganisms and foreign contaminants from being incorporated, raw water is supplied from the outside and taste, odor, color, particulates, disinfection by-products and pesticide residues are removed.

In the electrolyzed hydrogen generating and storing process, purified water is electrolyzed to generate hydrogen and the generated electrolyzed hydrogen is stored in a compressed activated carbon block provided on the top part of the electrolysis tank.

In the electrolyzed hydrogen water supplying process, a solenoid valve connected to an air vent filter is actuated to exhaust air to the outside, such that the electrolyzed hydrogen water is supplied by preventing air hammer in a pipe and facilitating the flow of water.

After the electrolyzed hydrogen water supplying process, a washing process as a process of removing scales in the electrolysis tank and on electrode bars and slime in the pipe is preferably further included.

That is, the water purifying process may comprise a first filtration configured by nonwoven fabric and activated carbon on the purpose of removing the taste, odor, color, particulates, disinfection by-products and pesticide residues from the raw water, such as tap water, ground water and the like, supplied from the outside, a second filtration configured by a reverse osmosis membrane of removing an inorganic material including heavy metals and an organic material, such as humic acid and the like, contained in the raw water, or a hollow-fiber type precision or an ultrafiltration membrane of removing various organic substances and microorganisms in addition to a mineral component in water, a third filtration configured by the nonwoven fabric and a cationic exchange resin or a chelated resin on the purpose of removing a tiny quantity of lead (Pb), iron powder, incrustation, and slime dissolved from a pipe material, such as a cast iron pipe and the like, of the raw water while the raw water passes sequentially, and a membrane contactor process installed on the purpose of removing gases, such as carbon dioxide, oxygen and the like, which are not removed from the processed raw water.

Further, in the electrolyzed hydrogen generating and storing process, when a positive and a negative electrode plates are installed on one surface of a rectangular or cylindrical container with certain space between those plates and direct current flows on the positive electrode plate and the negative electrode plate, gas is generated from both electrodes. And then 2 volume of electrolyzed hydrogen is generated from the negative electrode and 1 volume of electrolyzed oxygen is generated from the positive electrode, such that an ultrafine compressed activated carbon block filter or a ceramic filter with a precision or ultrafiltration pores subsequent to the activated carbon block filter is coupled and mounted onto the top of the electrolysis tank. As a result, when the electrolyzed hydrogen is stored and passed, high-concentrated electrolyzed hydrogen is contained in the purified water.

Further, in the electrolyzed hydrogen water supplying process, the stored electrolyzed hydrogen is drunk directly by using a water-taking cork or valve, or drunk as cold hydrogen water using a small-sized cooler after being transferred to a sealing-type cooling tank or drunk as hot water using indirect heating. Also, the solenoid valve connected to the air vent filter is actuated automatically to exhaust air to the outside and to remove interruption in the flow of water due to the gases contained in water when the electrolyzed hydrogen-containing hydrogen water is supplied to the cooling tank, thereby facilitating the flow of water in the pipe.

In addition, a washing process in which periodical cleaning of the purifier is preferably further included for safe maintenance since the scales may be formed in the electrolysis tank and on the electrode bars and incrustation or slime may be formed in the pipe as using the purifier for a long time.

In the washing process, even though the inside of the pipe is fully sealed, when the purifier is not used for a long time, the incrustation or the scales and sediments such as slime by microorganisms or the like are attached or applied to cause problems in water taste and health, therefore, approximately 5 to 50 g of citric acid is dissolved in 1 liter of purified water from a drainage side and the water passes through the electrolysis tank, the electrolyzed hydrogen storing filter, the water purifying tank, and the hot-water tank in sequence through the check valve by shutting off the solenoid valve and then opening the valve with a small-sized motor which is detachable from outside and, thereafter, is circulated through the check valve.

In this case, since a heater of the hot-water uses an indirect heating method, the heater is stopped for approximately several minutes to tens of minutes by supplying power after a washing liquid is circulated in order to maintain a temperature of the washing liquid in the range of 20 to 40° C. and then the washing liquid is fully drained by opening the valve and the solenoid valve is opened while the raw water is introduced and the raw water is drained for several minutes. Thereafter, each of the hydrogen water, the cold hydrogen water, and the hot hydrogen water flows out for approximately 1 minute and thereafter, the purifier is normally used. In this case, the solenoid valve attached to the air vent filter is closed during washing liquid draining and normal water purifying and opened during water taking or washing of the hydrogen water and the hot and cold hydrogen water.

Herein, the washing completion is judged when pH of washing liquid is in the range of 6.0 to 7.0 by using a pH measurer, and then the washing is stopped.

Table 1 shows a change in concentration of electrolyzed hydrogen of the water purifier according to the embodiment of the present invention and the water purifier in the related art. Table 2 shows a change in concentration of the electrolyzed hydrogen in an opened state and Table 3 shows a change of oxidation reduction potential (ORP) when the electrolyzed hydrogen is heated in the opened state.

In the measurement, dissolved hydrogen is measured by using an apparatus of Model No. DH-35A of TOA DKK of JAPAN and the oxidation reduction potential and the hydrogen ion concentration (pH) are measured by using Model No. WM-22EP of TOA DKK of JAPAN.

TABLE 1

| | | | | Dissolved | |
|---|---|---|---|---|---|
| | Water | | | hydrogen | |
| | temperature | | ORP | concentration | |
| Kind | (° C.) | pH | (mV) | (mg/l) | Remarks |
| Raw water (tap | 15.3 | 7.1 | +460 | <0.001 | Seoul |
| water) | | | | | |
| Purified water | 15.3 | 7.1 | +340 | <0.001 | Ultrafiltrator |
| | | | | | treatment |
| | | | | | water |
| Activated | 9.5 | 7.3 | −230 | <0.04 | Domestic |
| hydrogen water | | | | | releasing |
| (other | | | | | company |
| company) | | | | | |
| Direct- | 15.5 | 7.2 | −509 | 1.18 | Present |
| connection | | | | | invention |
| hydrogen water | | | | | |
| Cold hydrogen | 10.2 | 7.3 | −489 | 1.1 | Present |
| water | | | | | invention |
| Hot hydrogen | 58 | 7.4 | −480 | 0.96 | Present |
| water | | | | | invention |
| Alkali ion | 15 | 9.6 | −249 | 0.032 | Domestic |
| water purifier | | | | | releasing |
| | | | | | company |

In the present invention, the hydrogen concentration of the sealed hot and cold water tank is almost not changed, but the oxidation reduction potential is slightly lower than the raw water, but there is almost no electrolyzed hydrogen in the case of an alkali ion water purifier or a hydrogen generation reduced water (activated hydrogen generation) purifier which comes to the market domestically.

The reason might be that an open-type electrolysis tank in which generated hydrogen contacts air after electrolysis and electrolyzed hydrogen is sent to the purified water without the hydrogen storing filter, and as a result, hydrogen is not dissolved but discharged to the outside.

TABLE 2

| | | Dissolved | | |
|---|---|---|---|---|
| | | hydrogen | | Water |
| | ORP | concentration | | temperature |
| | (mV) | (mg/l) | pH | (° C.) |
| After passing through | −509 | 1.18 | 7.2 | 15.5 |
| hydrogen storing filter (just | | | | |
| after opening) | | | | |
| 1 hour later | −497 | 0.89 | 7.3 | 15.6 |
| 2 hours later | −496 | 0.8 | 7.1 | 15.9 |
| 3 hours later | −491 | 0.71 | 7.1 | 16.1 |
| 4 hours later | −487 | 0.66 | 6.85 | 16.5 |
| 5 hours later | −391 | 0.39 | 6.8 | 16.6 |
| Left in aluminum container | −501 | 1.16 | 7.2 | 24.3 |
| for 1 month | | | | |
| Left in aluminum container | −485 | 1.02 | 7.2 | 23.9 |
| for 3 months | | | | |
| Left in refrigerator for 3 | −498 | 1.05 | 7.16 | 8.3 |
| months | | | | |
| Left in PET bottle for | +102 | <0.01 | 6.87 | 21 |
| 2 days | | | | |
| Stored in refrigerator for 4 | +274 | <0.01 | 6.8 | 7.5 |
| days | | | | |

According to Table 2, the oxidation reduction potential or the dissolved hydrogen concentration is nominally reduced as time elapsed in the opened state in the atmosphere.

Further, when the hydrogen water is stored in an aluminum container, the hydrogen concentration are barely changed, but when the hydrogen water is stored in a PET bottle, the concentration of hydrogen is reduced almost to the same amount of the raw water.

TABLE 3

| Temperature (° C.) | ORP (mV) | pH |
|---|---|---|
| 15.5 (before heating) | −503 | 7.2 |
| 40 | −501 | 7.21 |
| 50 | −498 | 7.4 |
| 60 | −442 | 7.4 |
| 70 | −397 | 7.61 |
| 80 | −370 | 7.58 |
| 90 | −295 | 7.53 |
| 95 | −201 | 7.62 |
| After cooling (at 27° C.) | −23 | 7.83 |

According to Table 3, as the temperature of the hydrogen water taken in the hydrogen storing filter increasing, the oxidation reduction potential decreases.

The present invention is to solve the water pollution and health problems and the inconvenience by frequently cleaning the inside of the electrolysis tank and the inside of the pipe due to the introduction and proliferation of foreign substances and microorganisms in the electrolysis tank from the outside which are disadvantages of the open-type hot and cold water purifier which is widely used domestically and abroad.

To achieve this end, electrolysis tank is configured by a sealing-type instead of an open-type in the related art to prevent air contact with the outside, and as a result, the air vent filter is automatically opened when the cold water, the hot water, or the electrolyzed hydrogen water is used so as to automatically discharge air contained in the purified water at the time of supplying the purified water and in this case, the check valve is mounted after the air vent filter configured by the precision filtration or ultrafiltration membrane in order to prevent bacteria or the like from being introduced from the outside.

The purified water supplied in the water purifier in the related art is oxidation water in which the oxidation reduction potential (ORP) is plus mV, but the purified water of the present invention is the reduced water in which the ORP is minus mV and the purifier of the present invention is a functional water purifier that maintains the content of electrolyzed hydrogen 1.0/liter or more at a room temperature to assist maintaining the health by removing activated oxygen known as the cause of all kinds of illnesses.

It is apparent to those skilled in the art that the present invention is not limited to the embodiments but various modifications and changes can be made without compromising the scope of the present invention.

What is claimed is:

1. A sealing-type electrolyzed hydrogen-containing hot and cold water purifier for preventing microorganisms and foreign contaminants from being incorporated, which is constituted by a water purifying unit sending purified water filtered from raw water to an electrolysis tank, and an electrolyzing unit generating and storing electrolyzed hydrogen water by dissolving hydrogen gas, generated by non-diaphragm electrolyzing the purified water from the water purifying unit, in raw water, wherein:
the water purifying unit comprises a first filter, a second filter, a third filter and a membrane contactor,
the electrolyzing unit comprises an electrolysis tank, a hydrogen storing filter, an automatic solenoid valve, an air vent filter configured by a pore having a size in the range of 0.01 to 0.2 μm and a check valve, and
the electrolysis tank is formed in a sealing type and comprises a hydrogen storing filter constituted by a ceramic filter and an activated carbon filter.

2. The sealing-type electrolyzed hydrogen-containing hot and cold water purifier for preventing microorganisms and foreign contaminants from being incorporate as defined in claim 1, wherein the first filter is configured by nonwoven fabric, the second filter is configured by a reverse osmosis type or an ultrafiltration type filter depending on the concentration of total dissolved solids, and the third filter is configured by an ion exchange resin and the nonwoven fabric for removing dissolved lead.

3. The sealing-type electrolyzed hydrogen-containing hot and cold water purifier for preventing microorganisms and foreign contaminants from being incorporate as defined in claim 1, wherein the electrolysis tank is made of a polymer plastic material such as transparent polysulfone and all pipes from the hydrogen storing filter to water taking points are made of a titanium.
